(19) United States
(12) Patent Application Publication
(10) Pub. No.: US 2004/0150665 A1
(43) Pub. Date: Aug. 5, 2004

(54) Selection of statistical tool

(75) Inventor: George Henry Dyson III, Cincinnati, OH (US)

Correspondence Address: Barbara Joan Haushalter, 228 Bent Pines Court, Bellefontaine, OH, 43311, US

(73) Assignee: General Electric Company

(21) Appl. No.: 10/761,963

(22) Filed: Jan. 20, 2004

Related U.S. Application Data
(63) Continuation of application No. 09/687,421, filed on Oct. 13, 2000, now abandoned.

(51) Int. Cl. G09G 5/00

(52) U.S. Cl. 345/742

(57) ABSTRACT

A system and method are provided for selecting a statistical tool or technique to solve data driven user problems. Using a hierarchical decision logic flowdown structure, the user makes progressive data type selections. Selection expansions are offered to the user, based on the data type selections. The selections of the user result in selection of a web-based statistical software tool. Data can be input to the web-based statistical software tool, and an analysis of the most frequently encountered technical problems in industry, business and teaching environments, is made. This all results in the expeditious and proper statistical solution to a problem, based on the data driven selections.

### BACKGROUND OF THE INVENTION

The present invention relates to an internet based logic structure for selecting the proper statistical tools and techniques, with a link for enabling proper software selection tools for the desired application.

With the advent of statistical thinking and problem solving centered around the customer's analysis of a problem, there has been a recent evolution of industry-based training centered around using statistical thinking to solve data driven customer problems. With infrequent use of these software skills and the necessary link to the methodology, the ability to use these skills deteriorates. Therefore, guidance must be made available to the casual or infrequent user to reinforce the interaction between the methodology and selection of the proper statistical tool or technique used to solve data driven problems.

Historically, problems have been solved using either personal computer or mainframe based statistical software with little front end support to help guide the user to the proper tool. The user must either know what specific tool is wanted, or have the help of a statistician. Without periodic reinforcement of the training, the infrequent user has a harder time selecting the proper tool or technique. This can result in solving the problem incorrectly or not at all. As a result, the problem solver can become disenchanted and may avoid these statistical problem solving tools altogether.

It would be desirable to provide a simplified link between statistical jargon and the application or problem to be solved. The wizard of the present invention provides a statistical consultant to the user that links the methodology and the software.

### BRIEF SUMMARY OF THE INVENTION

A JAVA based, flowdown-structured statistical wizard is proposed for selecting the proper software tool for a given application. This approach provides the logic to link the need, expressed in simple statistical jargon, with the appropriate statistical software tool. With the statistical wizard of the present invention, the user simply clicks on one of multiple boxes displayed on the computer screen. Each click, in turn, opens additional alternative choices to help identify the problem type in a sequential manner until the end software tool is selected. The wizard of the present invention puts decision logic into logic paths using JAVA decision flowcharts. The JAVA web-based language can then be linked to any html based software.

Accordingly, the present invention provides a flowdown structure for providing decision logic to allow a user to select a statistical tool. The structure comprises inputs provided by the user in a sequential manner. The data type is selected in a hierarchical decision logic flowdown based on the inputs. A statistical software tool is opened based on decisions made in the flowdown. The present invention provides an analysis selection tool that walks the user, step by step, through a straightforward logic path using JAVA decision flowcharts to select the proper statistical tool.

### BRIEF DESCRIPTION OF THE DRAWINGS

FIG. 1 is a schematic diagram of a statistical problem solving system that embodies the present invention;

FIG. 2 illustrates one embodiment of an exemplary series of steps the user can follow to determine the correct statistical tool to use in solving the problem; and

FIG. 3 illustrates data type selection results using the statistical wizard of the present invention.

### DETAILED DESCRIPTION OF THE INVENTION

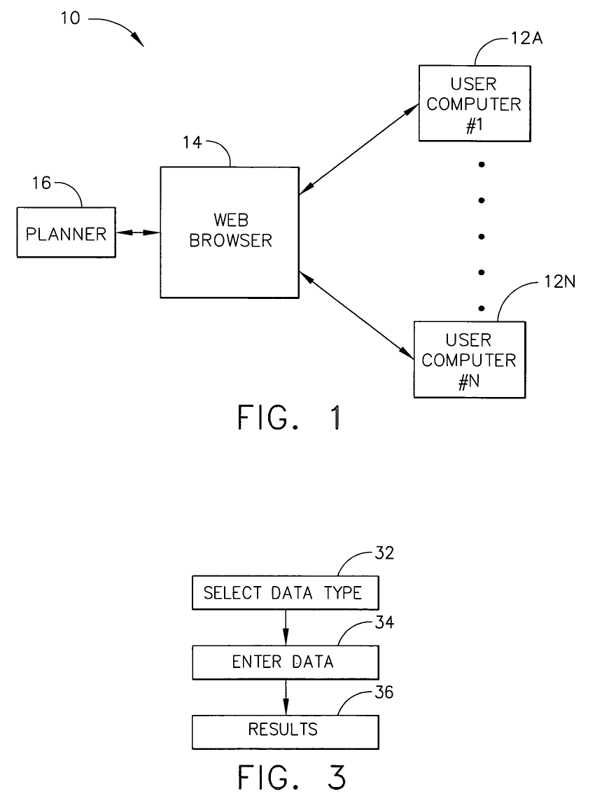

Referring to FIG. 1, there is a schematic block diagram 10 illustrating a statistical selection system 10 for identifying the proper software tool for a given application. The system 10 can comprise one or more user computers 12A-12N. In one embodiment, the user computers 12A-12N are each capable of transmitting requests for statistical tools software over a digital communication network and receiving information for enabling a proper software selection tool subsequently conveyed over the network in response to the requests. Alternatively, the computer(s) 12A-12N may comprise a stand-alone system with web-browser access installed in the stand-alone system, or accessible over a web-browser server system. Any suitable storage media may be used to upload information to the computer(s), such as, for example, a CD-ROM.

Regardless of whether the information is accessed via an internet, intranet, extranet, a storage media, or a stand-alone means, each client system 12A-12N is capable of offering selections relating to a problem that is to be solved using statistical thinking. The user responds to a series of data type selections in a flowdown structure in order to identify the problem. The client system 12A-12N is capable of receiving menu driven selections conveyed in response to each selection made by the user. The receiving and conveying may comprise any suitable means, such as a network 14. The digital communication network 14 conveys the selections of the user to a planner 16, and receives the subsequent selection alternatives recommended by the planner 16 based on the previous selections of the user at 12.

Continuing with FIG. 1, the network 14 can comprise any kind of digital communication means or combination of digital communication means. For example, the means can be a network with a controlled-access web browser, local area network (LAN), wide area network (WAN), or other limited access intranet or extranet means. Alternatively, the network can comprise a digital communication network or combination with access to a web browser or the World Wide Web, or any combination of networks. Likewise, the user computers 12A-12N and planner 16 can be of any form so long as the requests and recommended process sequences can be communicated between the user computer 12 and the planner 16. In the illustrated embodiment, the network 14 comprises a web browser. Consequently, the user computer 12 utilizes a web browser to access planner 16, which can be implemented in the form of a web server. In a preferred embodiment, planner 16 is a JAVA based flowdown structure whereby the user responds to a series of data type selections to identify the problem, and the planner provides links to statistical tools software.

It is also feasible to integrate the planner 16 into each of the user computers 12A-12N to create a stand-alone system. In this case, the network 14 can be used to update the planner 16 resident in each of the computers 12A-12N. The stand-alone system is particularly useful in situations where the integrity or ability to use the network 14 is unreliable. Alternatively, the planner 16 can be downloaded to the user computer each time a statistical tool is requested from the planner 16.

The planner 16 provides each of the user computers 12A-12N with an interface that permits the user to convey requests for a recommended process sequence and receive the recommended process sequence. The interface includes an input portion and an output portion. The input portion of the interface is used to convey information from the user's computer to the planner 16. The output portion conveys information from the planner 16 to the user computer and is typically displayed on the monitor of the user's computer. However, the output portion is capable of being displayed on other output peripherals, like printers. Typically, the input information is generated by the user's actuation of an input peripheral, such as a mouse or a keyboard.

In the illustrated embodiment of FIG. 1, the interface is provided by web pages that are transmitted by the planner 16 to each of the user computers 12A-12N. A web page includes input and/or output portions. The input portion of a web page allows the user to enter information relevant to a request for a statistical tool and/or technique with an input peripheral, such as a mouse or keyboard. The output portion of a web page is used to provide the user with the correct statistical tool. In addition, the output portion of a web page is used to solicit information relevant to the selection of the proper software selection tool for the desired application from a user. In this case, the web page includes both input and output portions.

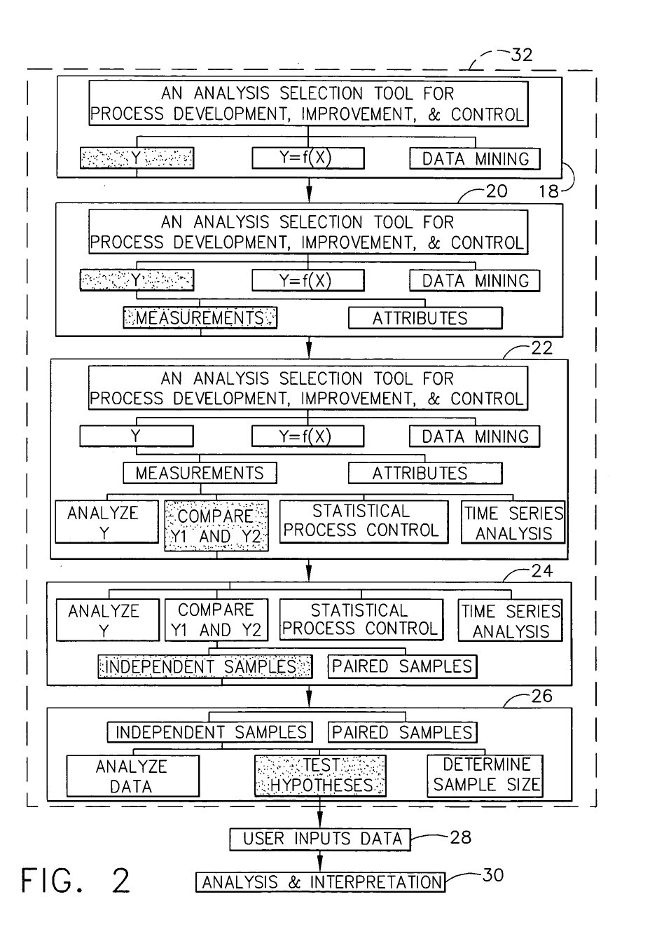

In assembling a request for selection of a statistical tool or technique, the present invention provides an analysis selection tool that walks the user through a simple logic path using JAVA decision flowcharts to select the proper statistical tool. In an exemplary embodiment, illustrated in FIG. 2, the interface is initially used to solicit input from the user concerning the problem of the customer that requires the use of statistical thinking. In the illustrated embodiment, a web page 18 is conveyed from the planner 16 to the user's computer that includes a hierarchical menu that allows the user to identify the appropriate model based on the users need and type of data. Specifically, these data could be univariate or single variable data in which the user would select “Y”. If the data were mutivariate implying a cause and effect relationship between several variables, the user would select Y=F(X), which is read as Y as a function of X, to relate multiple variables. If the user were interested in the exploration of those data, “Data Mining” would be chosen.

Preferably, the highest level of the menu has selections for general types of data for which the proper statistical tool is to be generated. These could include, but are not limited to, univariate, multivariate or data mining. Various other formats could be included as well. Indeed, the present invention is not necessarily limited to process development, improvement and control, but could be applicable to any sort of problems that requires statistical thinking.

Selection of the top level menu item, based on the type of data to be analyzed, results in a sub-menu from which the user selects the next menu item at a more detailed level. For instance, under the Single Variable Y function, sub-menus for either Measurements (variable data) and Attribute (discrete data) exist, as shown in the second step, display block 20, of FIG. 2. Likewise, under the Data Mining function of display block 18, there is a sub-menu that specifies different communication software selections, and so on for other functions.

In most cases, however, the selection at the top level menu does not provide sufficient data for a communication software selection to be specified. Consequently, the additional sub-menu interface is used to solicit information from the user concerning the selected feature or statistical problem.

In the illustrated embodiment, the planner 16 provides a user's computer with an input form that causes a dynamically written input screen to be displayed on the user's monitor or other peripheral. The input screen allows the user to both select inputs from a menu of items already contained in the input form and to input information. FIG. 2 illustrates an exemplary series of sequentially displayed screens that are provided to the user's monitor based on each selection made by the user in the flowdown sequence. Each display screen solicits a selection by the user to provide additional alternative choices to help identify the problem type in a sequential manner until the end software tool is selected.

Continuing with the exemplary embodiment of FIG. 2, when One Y is selected at display block 18, and Measurements is selected at display block 20, additional selection alternatives are provided to the user, as shown in display block 22. These choices can include, for example, an analysis of Y, a comparison of multiple Y's, Statistical Process Control and a Time Series Analysis.

The flowdown continues until enough data is gathered to select the proper statistical tool or technique. If, for example, the user selects Compare Y1 and Y2 at display block 22, the user receives a monitor display such as is shown in display block 24, again with additional alternative choices based on the previous (i.e., Compare Y1 and Y2) selection. For example, the comparison can be Independent Samples or Paired Samples. If the user clicks on, for instance, Independent Samples, the flowdown sequence offers the display shown in display block 26, where the data can be analyzed, the hypothesis tested, or the sample size determined.

Once the user has clicked on the selected choice at each level in the flowdown sequence, the user can input data type selections, as shown by block 28. Based on all of the selected choices of the user and the data from the user, the wizard of the present invention uses JAVA web-based language that can be linked to any html based software. The html based software provides the user with an analysis and interpretation option for the original problem, as at block 30. All of this is achieved with a hierarchical logic flowdown structure illustrated as the blocks of box 32, with an emphasis on speed and simplicity. As a safeguard, the system of box 32 cannot be bypassed, requiring the user to go through the steps such as are illustrated in FIG. 2 to receive the proper statistical tool. Also, the framework of the web wizard can be enhanced to include instructional material and other information. Software upgrades can be provided on the internet with no customer interaction needed, and the system can be browser independent.

As illustrated in FIG. 3, solid line boxes within 32 expand the selection for the user and eventually launch an applet for the user. The applets link the user directly to communications software, to give the user an analysis and interpretation option. After selecting the data type, by following the flowdown sequence of 32, the user enters data, as illustrated by step 34 of FIG. 3. Based on the user selections and the data input, the user receives statistical tools and techniques at results step 36.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for selecting a statistical tool or technique, comprising:
a hierarchical decision logic flowdown structure in which a user makes progressive data type selections;
selection expansions offered to the user based on the data type selections; and
a statistical software tool that is opened based on the data type selections.

2. A system as claimed in claim 1 wherein the system comprises an internet-based system.

3. A system as claimed in claim 1 wherein the system comprises a stand-alone system.

4. A system as claimed in claim 1 further comprising a means for the user to enter input data into the statistical software tool.

5. A system as claimed in claim 4 wherein the means for entering input data comprises a user input peripheral.

6. A system as claimed in claim 4 further comprising an analysis of frequently encountered technical problems encountered in various environments.

7. A system as claimed in claim 6 further comprising statistical based solutions based on the progressive data type selections, the input data and the analysis.

8. A system as claimed in claim 1 wherein the data type selections comprise univariate, multivariate and data mining data type selections.

9. A system as claimed in claim 1 wherein the hierarchical decision logic flowdown structure continues with progressive data type selections and selection expansions until sufficient data is gathered to properly select the statistical tool or technique.

10. A method for selecting a statistical tool or technique for addressing a problem of the user, comprising the steps of:
providing a computer network for communicating digital data between at least two locations;
first conveying, using the computer network, data selections and input data to request a statistical tool or technique, the data selections and input data originating at a first location and directed to a second location;
processing, at the second location, the data selections and input data; and
second conveying, in response to the data selections and the input data, a response that includes the recommended statistical tool or technique, said response originating at the second location and directed to the first location.

11. A method as claimed in claim 10 wherein the data selections comprise progressive data type selections in a hierarchical decision logic flowdown structure, with selection expansions offered to the user based on the data type selections made at each selection level.

12. A method as claimed in claim 10 wherein the step of processing comprises the step of using JAVA web-based language that can be linked to any html based software.

13. A method as claimed in claim 10 wherein the step of second conveying comprises the step of providing the user with an analysis and interpretation option for the problem.

14. A method of identifying a statistical tool or technique to address a user problem, comprising the steps of:
a. under control of a client system,
displaying information identifying selections;
in response to selections made, displaying additional selectable information in a flowdown sequence;
b. under control of a web browser system,
receiving the selectable information and receiving user input data; and
providing a correct statistical tool for the client by linking statistical methodology with the problem to be solved, based on the selected information and the user input data.

15. A method as claimed in claim 14 wherein the steps of displaying and receiving comprise the step of using a JAVA based, flowdown-structured, statistical wizard to identify the statistical tool or technique.

16. A method as claimed in claim 14 wherein the steps of displaying and receiving are carried out on a digital communication network.

17. A method as claimed in claim 14 wherein the steps of displaying and receiving further comprise the step of utilizing a web browser.

18. A method as claimed in claim 14 wherein the web browser system is capable of providing links to statistical tools software.

19. A method as claimed in claim 14 wherein the client system comprises at least one user computer capable of transmitting selections relating to a problem that is to be solved using statistical applications.

20. A method as claimed in claim 14 wherein the client system comprises at least one computer capable of transmitting requests for statistical tools over a digital communication network and receiving information for enabling identification of a software tool.
